(19) United States
(12) Patent Application Publication
(10) Pub. No.: US 2016/0311097 A1
(43) Pub. Date: Oct. 27, 2016

(54) DRIVING-IN DEVICE

(71) Applicant: HILTI AKTIENGESELLSCHAFT, Schaan (LI)

(72) Inventor: Matthias Blessing, Frastanz (AT)

(21) Appl. No.: 15/104,352

(22) PCT Filed: Dec. 16, 2014
(86) PCT No.: PCT/EP2014/077874

§ 371 Date: Jun. 14, 2016

(30) Foreign Application Priority Data
Dec. 18, 2013 (EP) 13198045.0

(51) Int. Cl. B25C 1/14

(52) U.S. Cl. CPC B25C 1/143

(57) ABSTRACT

Disclosed is a driving-in device comprising a hand-held housing in which a piston member is accommodated to transmit energy to a fastening element to be driven in, an especially replaceable propellant charge, and a combustion chamber which is located between the propellant charge and the piston member and which extends in particular around a central axis (A), and a control element which allows the energy transmitted from the propellant charge to the piston member to be variably modified. Said driving-in device is characterized in that a movable sliding element of the control element forms a section of a sidewall of the combustion chamber, said section adjoining the piston member.

The invention concerns a driving-in device as in the generic part of claim 1 and a system for driving a fastening element into a workpiece according to the features of claim 14.

Hand-held driving-in devices having propellant charges, in which combustion gases resulting from the ignition of a pyrotechnic charge expand in a combustion chamber, are known from the prior art. Through said expansion a piston is accelerated as an energy transmission means and drives a fastener into a workpiece. Basically speaking, a combustion of the charge that is as optimized, residue-free, and reproducible as possible is desired in this case. It must be taken into account that, as a rule, the charge comprises particles such as powder grains, fibers, or the like, which after an ignition are driven ahead of a flame front.

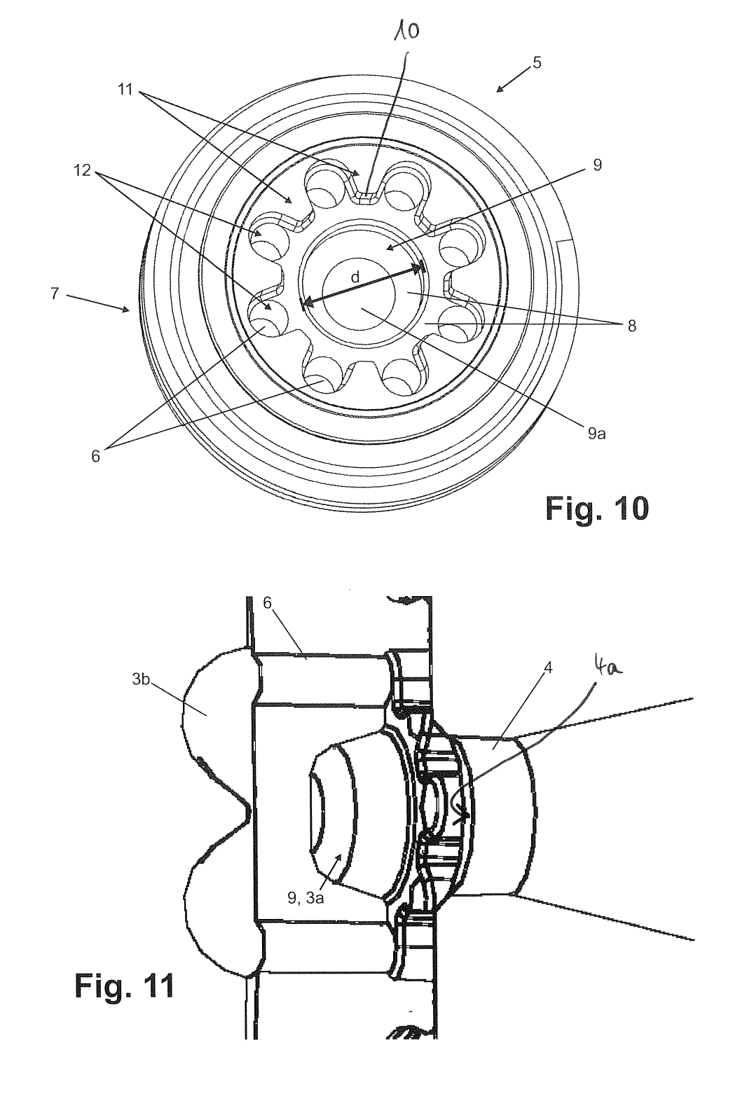

U.S. Pat. No. 6,321,968 B1 describes a driving-in device having a propellant charge, in which the combustion chamber is separated into an upper partial chamber and a lower partial chamber by means of a perforated plate. The powder grains of the propellant charge in this case are larger than the orifices in the plate. Thus, the powder grains are accelerated initially in a central discharge region against the perforated region of the separating plate, where they are retained because of the dimensioning of the orifices of the separating plate, so that combustion of the powder grains takes place chiefly in the upper partial chamber. FIG. 10 shows a modification in which a propellant charge without a casing is used. In this variation, due to the design there is not a discharge region that includes the central axis provided in the upper partial chamber, and said discharge region extends between the propellant charge and a central region of the separating plate. In the example in FIG. 10, the discharge region therefore does not include the central axis of the combustion chamber, but rather is disposed in an annular shape around a central ram of the combustion chamber. The ignition of the caseless charge then takes place at an upper end of the central ram.

U.S. Pat. No. 6,321,968 B1 additionally shows an adjustability of the dead space volume, in order to be able to adjustably change the driving energy of the device. For this, a valve-like plate can be moved in a direction perpendicular to a driving axis. In this case, even when the plate is in the closed position, the combustion chamber has a dead space, which is formed as a recess in a side wall of the combustion chamber.

It is the problem of the invention to specify a driving-in device that enables an effective adjustment of a driving energy for a given propellant charge.

This problem is solved in accordance with the invention, for a driving-in device of the kind mentioned at the start, by means of the characterizing features of claim 1. The formation of the section of the side wall of the combustion chamber adjacent to the piston by means of the movable slide of the control element makes it possible that no or nearly no additional volume due to the control element is provided in the combustion chamber when the slide is closed. Through this, a control range of the control element extends to the possibility of a particularly high driving energy.

The bounding of the section formed by the slide on the piston element is defined so that the piston is guided either while directly contacting the slide or while there remains a defined gap between the slide and the piston element. If it is necessary to avoid a contact between the piston element and the slide, such a gap serves to support a low-friction movement of the slide and to avoid undesirable material wear. In the case of such noncontact design of the slide, it can nevertheless be achieved within dimensional tolerances that nearly no additional volume due to the control element remains.

An additional volume of the combustion chamber is understood to be a closed volume that is provided in addition to a basic geometric form of the combustion chamber including the piston element and that connects to the combustion chamber. An additional volume in the narrower meaning of the invention is in this case a volume added to the combustion chamber that is due to the design of the control element. Other additional volumes, for example, recesses in a bottom of the piston element to improve combustion or similar measures can be provided without prejudice.

A driving energy in the meaning of the invention is understood to be the kinetic energy of the piston element striking a given fastener for a given propellant charge. When specifying these boundary conditions, the control element enables the resulting driving energy to be adjustably changed for the fastener.

A piston element in the meaning of the invention is any means that becomes accelerated with kinetic energy due to the ignition of the charge, where the kinetic energy is ultimately transmitted to the fastener. The piston element is frequently designed in particular as a cylindrical piston. Recesses or other structures that additionally promote turbulence and uniform expansion of the combustion gases can be provided in the bottom of the piston.

A fastening element in the meaning of the invention is understood to be generally any drivable anchoring device, for example nails, bolts, or screws.

A central axis in the meaning of the invention is an axis that is at least parallel to the movement of the fastening element and that runs in particular through a center of the combustion chamber.

In a generally preferred embodiment of the invention, the slide is movable parallel to the axis, through which a simple and effective mechanical implementation becomes possible. In an alternative embodiment of the invention, the slide is movable transverse to the axis, preferably perpendicular to the axis.

Preferably, an exit cross section of an exhaust channel is variably adjustable according to the position of the slide. An exhaust channel in the meaning of the invention is understood to be a channel by means of which the combustion gases of the propellant charge are exhausted into the environment or into another large volume, for example a gas storage compartment for a piston return. Through this, a particularly large and rapid pressure loss in the combustion chamber can be achieved according to the cross section of the exhaust channel.

In one particularly preferred embodiment, an additional volume of the combustion chamber is adjustable by moving the slide. A particularly fine energy regulation can take place through this. Preferably, the regulation begins starting from a zero or nearly zero additional volume.

In a preferred improvement, an increasing additional volume of the combustion chamber is unblocked by moving of the slide starting from a closed position, and with further travel of the slide, the exhaust channel becomes unblocked continuously or in steps. A particularly favorable control characteristic with an especially wide range of energy adjustment can be achieved through this. In particular, even for wide ranges of energy adjustment, a nearly linear connection between an adjustment path of the slide and the reduction of the driving energy can be achieved. In an alternative embodiment, first the exhaust channel, and with further adjustment of the slide an increasing additional volume of the combustion chamber is unblocked. In another alternative embodiment, an increasing additional volume of the combustion chamber and of the exhaust channel are unblocked at the same time.

Generally advantageously, the side wall of the combustion chamber forms a closed surface of rotation about the central axis when the slide is closed. In this case, a surface of the slide is a part of the surface of rotation, in particular of a cylindrical segment of a side wall of the combustion chamber.

For optimum avoidance of the additional volume when the slide is closed, the section of the side wall formed by the slide has a concave surface. For example, it can be matched to a curved wall of the piston element.

In an especially preferred embodiment of the invention, a surface of the slide has two partial surfaces, where a first partial surface forms the segment of the side wall of the combustion chamber and where a second partial surface forms a segment of a bottom surface of the combustion chamber. With such a shape, the slide can, in closed state, for example, complete an L-shaped segment of the combustion chamber wall. When the slide moves, the part forming the segment of the bottom surface can be moved back and in this way provide an adjustable additional volume, through which the combustion gases can flow even before or immediately after a first movement of the piston element.

In another alternative or even supplemental embodiment, the slide extends in a closed position over the entire length of the combustion chamber, and a slide guide channel leads to an exhaust channel at a forward end of the combustion chamber. This enables a particularly simple and effective design of the control element.

In a generally advantageous embodiment of the invention, the combustion chamber is divided, by means of a separating member having a plurality of through-holes, into a first partial chamber adjacent to the propellant charge and at least one second chamber adjacent to the piston element, where an exhaust region for the propellant charge is provided in the first partial chamber, said region extending between the propellant charge and a central region of the separating member. The discharge region preferably includes the central axis, i.e., the central axis runs through the discharge region.

Especially preferably, the exhaust region abuts the central region of the separating member through a closed surface of the separating member. Through the presence of the closed surface in the central region of the separating member, particles of the charge that are discharged into the combustion chamber after the ignition are first reflected or deflected regardless of their size before they come into contact with one of the through-holes. In this modified way, the particles can then be distributed uniformly in the upper partial chamber while they are being acquired by a flame front and likewise being ignited.

Overall, a combustion of the propellant charge that is as good and as complete as possible is ensured by this. This is true especially when the driving energy is set to a small value via the control element and therefore large additional volumes and/or exhaust orifices affect the combustion of the propellant charge.

A discharge region in the meaning of the invention is a prismatic, most often cylindrical space, the cross section of which is defined by a surface of the igniting charge directed into the combustion chamber and which extends perpendicular to the surface. If the propellant charge is provided in the form of a cartridge, the surface of the charge is defined here as the exit surface of the opened cartridge. In this case, the discharge region is essentially cylindrically shaped. Its diameter corresponds to the inside diameter of the cartridge seat at its exit in the output direction of the piston element.

The central axis in the meaning of the invention runs as the focal line through the discharge region. As a rule, but not necessarily, the central axis coincides with an axis of travel of the piston element.

A separating member in the meaning of the invention is any structure by which the combustion chamber is divided into two partial chambers. Preferably, the separating member runs transverse to the central axis. For example, it can be made as a plate with multiple drillings.

The central region of the separating member is preferably not perforated, so that at the least a considerable portion of the initially discharged particles moves within the discharge region through the first combustion chamber toward the central region without first passing through the separating member into the second partial chamber.

Preferably, the closed surface of the central region is larger than a cross section of the separating member having the discharge region.

In generally preferred embodiments of the invention, the central region of the separating member has a depression. An especially good rebound of the deflected particles and turbulization of the combustion gases can take place in the first partial chamber because of this depression.

In a preferred development, the depression is made as a bowl-shaped recess in the separating member. This promotes scattering and turbulization particularly highly.

For further improvement of the scattering and turbulization a projecting part is made in a central bottom region of the recess in a preferred embodiment. The projection can, for example, be cone-shaped.

Alternatively or in addition, it is provided that the depression has a diameter that decreases downwardly, which likewise produces good distribution of powder grains and combustion gases.

For an optimum effect of the depression on a large portion of the propellant charge, it is preferably provided that a maximum diameter of the depression, extending perpendicular to the central axis, make up not less than 80% of a maximum diameter of an orifice of the propellant charge extending perpendicular to the axis. Especially preferably, the diameter of the depression is greater than the diameter of the orifice of the propellant charge.

To improve the turbulizing effect of the depression, it is also preferably provided that a maximum depth of the depression measured in the direction of the axis be not less than 30%, especially preferably not less than 50%, of a maximum diameter of the depression measured perpendicular to the axis.

Generally advantageously, a leg is provided between each two adjacent through-holes, where combustion gases of the propellant charge flow from the discharge region first radially outward between the legs before they flow through the through-holes in the axial direction after being deflected. The deflection and turbulization of the combustion gases is optimized still further by this, and an undesired penetration of coarse powder grains into the through-holes is further reduced.

Generally preferably, it can be provided that the through-holes of the separating member have a cross section that is larger than a maximum cross section of the particles of the propellant charge. This prevents a clogging of the through-holes by combustion residues. Through the other features of the invention, an entry of large powder grains into the second partial chamber is largely avoided in spite of relatively large through-holes.

In the interest of simple assembly and maintenance, the separating member is preferably screwed into the combustion chamber by means of an external thread made on it.

It is provided in a generally preferred embodiment of the invention that in the control range, for a given propellant charge, a maximum driving energy that can be adjusted by means of the control element corresponds to at least twice the minimal driving energy that can be adjusted with the control element. Preferably, the maximum driving energy is at least 2.5 times the minimum driving energy. In an advantageous design, the minimum driving energy is no more than 150 joules and the maximum driving energy is no less than 250 joules. Overall, a particularly universal use of the driving-in device can be enabled by this without a number of propellant charges of different strength having to be kept on hand for each use.

Generally, an at least partially automatic setting of the driving energy can take place by means of an electronic device control. The necessary specifications for this, for example regarding the type and size of the workpiece, can be taken by an operator. Alternatively or in addition, sensory information, for example about the type of fastener to be set, can be used.

The problem of the invention is also solved by the features of claim 15 for a system for driving a fastening element into a workpiece. This enables a driving-in device according to the invention to cover a wide range of driving energy with only one propellant charge. Correspondingly, the supply of other propellant charges for operation of the device can be omitted.

Other features and advantages of the invention result from the embodiment examples and the dependent claims. A number of preferred embodiment examples of the invention are described below and explained in more detail by means of the attached drawings.

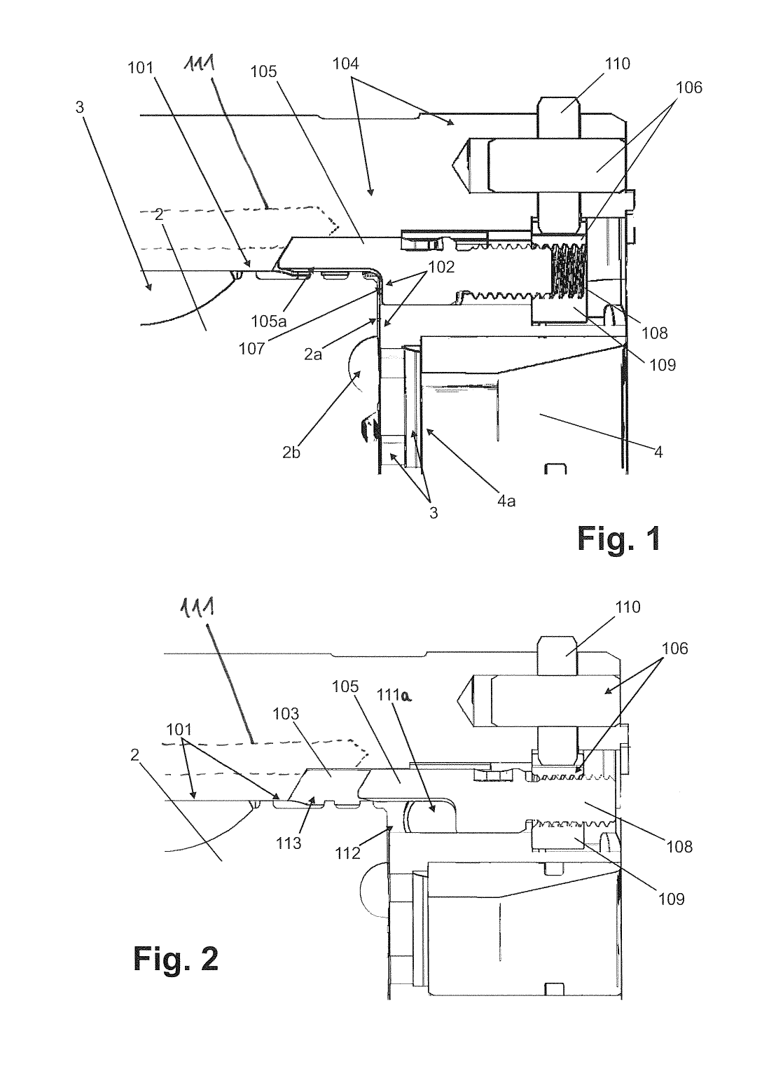

FIG. 1 shows a partial sectional view of a combustion chamber of a driving-in device according to the invention with closed slide in accordance with a first embodiment example.

FIG. 2 shows the driving-in device from FIG. 1 with fully unblocked slide.

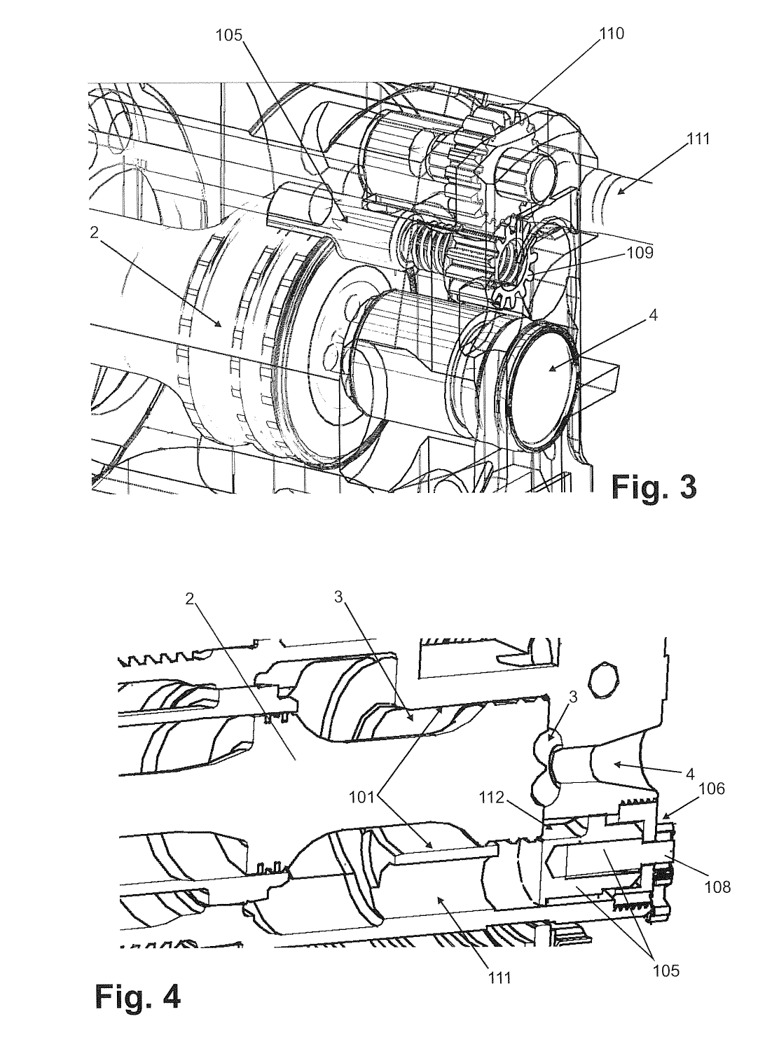

FIG. 3 shows a three-dimensional detail view of the device from FIG. 1 in the region of the combustion chamber.

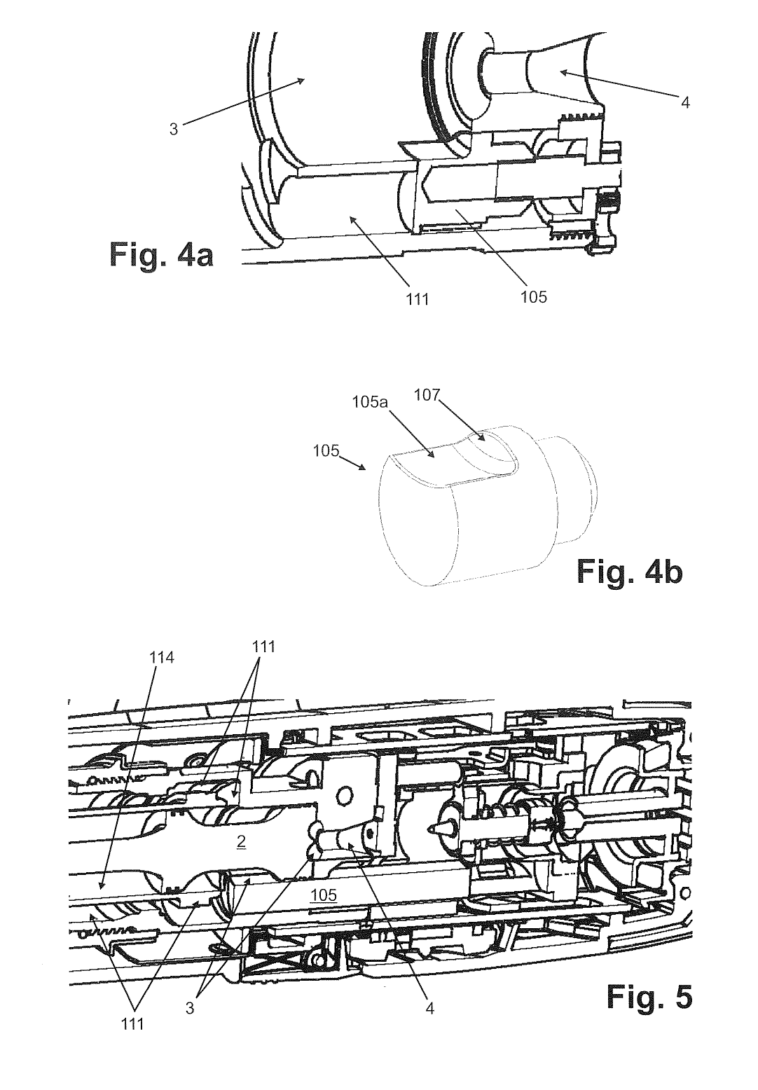

FIG. 4 shows a three-dimensional sectional view of a modification of the driving-in device from FIG. 1 with unblocked slide.

FIG. 4a shows the example from FIG. 4 with closed slide.

FIG. 4b shows a three-dimensional view of a slide of the driving-in device from FIG. 4.

FIG. 5 shows a sectional view of another embodiment example of the invention with closed slide.

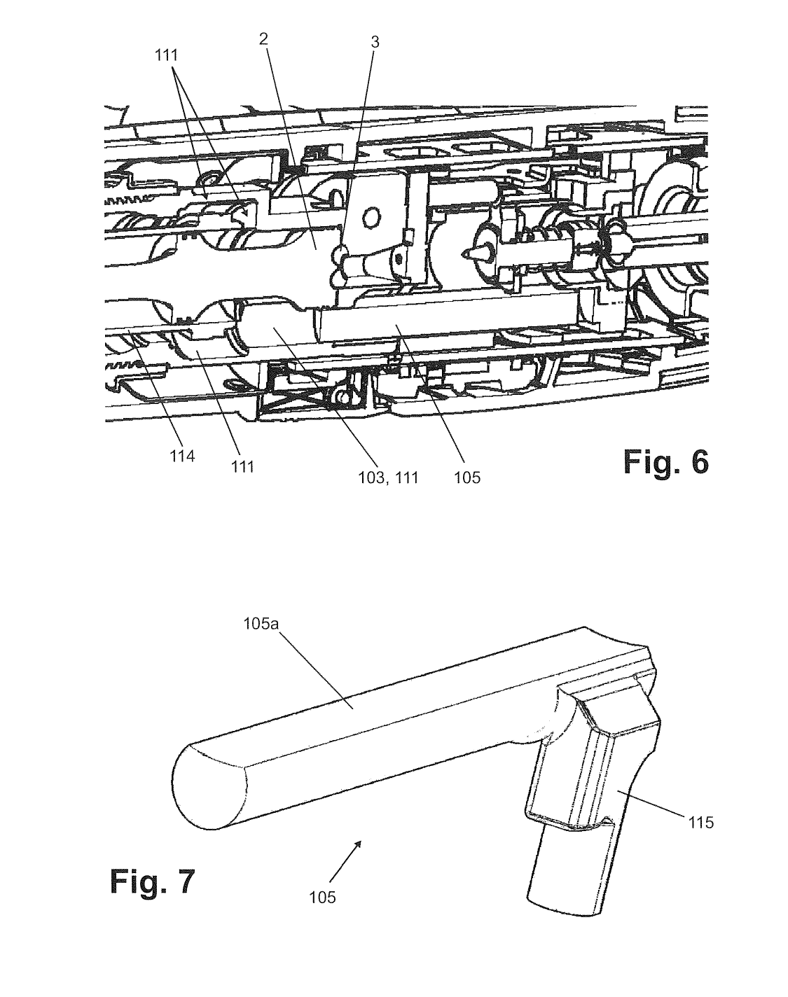

FIG. 6 shows the driving-in device from FIG. 1 with partially unblocked slide.

FIG. 7 shows a three-dimensional view of a slide of the driving-in device from FIG. 5.

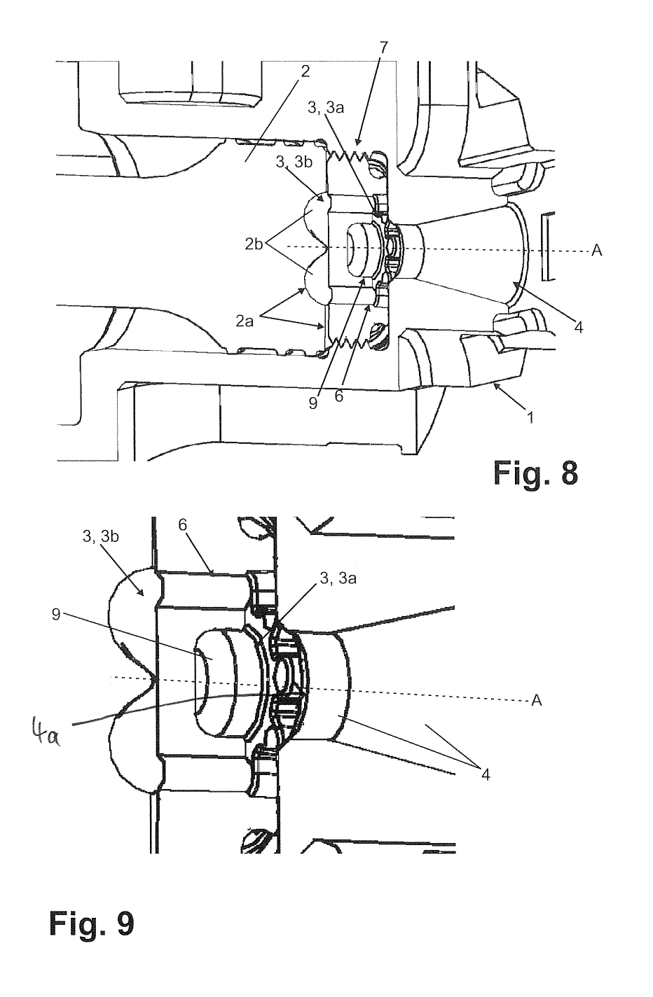

FIG. 8 shows a three-dimensional sectional view of a combustion chamber of a driving-in device with a separating member.

FIG. 9 shows a three-dimensional detail view of the combustion chamber from FIG. 8.

FIG. 10 shows a three-dimensional view of a separating member of the combustion chamber from FIG. 8.

FIG. 11 shows a three-dimensional view of a combustion chamber with a second embodiment example of a separating member.

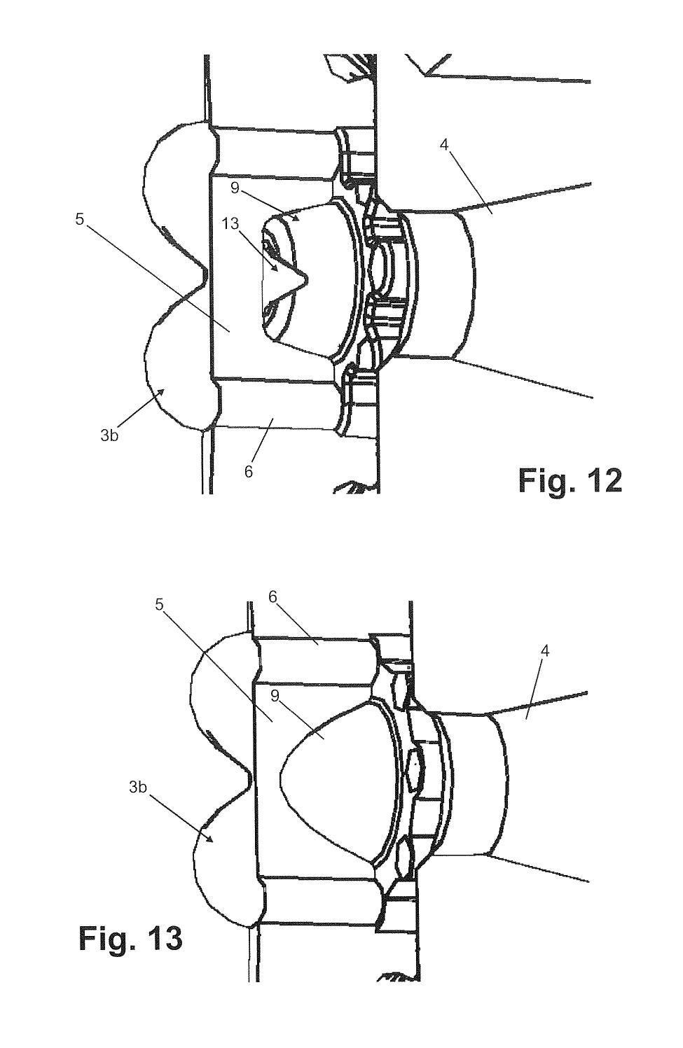

FIG. 12 shows a three-dimensional view of a combustion chamber with a third embodiment example of a separating member.

FIG. 13 shows a three-dimensional view of a combustion chamber with a fourth embodiment example of a separating member.

A driving-in device according to the invention comprises a hand-held housing, in which a piston element in the form of a piston 2 is accommodated. A surface 2a of the piston 2 abuts a combustion chamber 3, in which the combustion gases of a pyrotechnic charge expand in order to accelerate the piston 2. The pyrotechnic charge is solid, preferably in powder form. In embodiment examples that are not shown, the pyrotechnic charge is in liquid or gas form.

The piston 2, which is thus accelerated with kinetic energy, strikes, with its piston shaft, a fastening element, which is driven into a workpiece by this.

The charge in this case is accommodated in a cartridge made of sheet metal. The cartridge has a percussion igniter and, before the ignition, is inserted into a cartridge seat 4 by means of an appropriate loading mechanism.

The cartridge and cartridge seat are preferably made rotationally symmetrical about a central axis A. The central axis A in these examples is at the same time a central axis of the combustion chamber 3 and the piston 2.

The combustion chamber 3 is disposed between a circular orifice 4a of the cartridge seat 4 and the surface 2a of the piston 2. In this case, an annular depression 2b is made in the piston 2, the depression contributing to better turbulization of the combustion gases and being a part of the combustion chamber 3.

The combustion chamber 3 here has a side wall 101, which is made as a closed surface of rotation of a parallel line about the central axis A, thus as an internal cylinder. In addition, the combustion chamber 3 has a bottom surface 102, which is essentially extended perpendicular to axis A. In an initial state of the piston element 2, a bottom surface of the piston element 2 lies on the bottom surface 102 of the combustion chamber 3.

A control element 104 is provided to adjustably change a kinetic energy acquired by the piston element 2 for a given propellant charge and thus to change the adjustable change of a driving energy. The control element 104 comprises a slide 105 and a mechanism 106 for adjusting a position of the slide 105.

The slide 105 can be moved parallel to axis A. A segment of the slide 105 that is forward in the driving direction has a surface 105a that is concavely shaped about the axis A. Thus the surface 105a of the slide 105 is a part of the side wall 101 of the combustion chamber 3. The concave surface 105a in this case partly surrounds a side wall of the piston element 2 and is in contact with rings or circumferential beads that project for sealing purposes on the piston element.

The concave surface 105a forms a first partial surface of the slide 105. A second partial surface 107 of the slide 105 likewise forms a segment of the surface of the combustion chamber. Said segment is a part of the bottom surface 102 of the combustion chamber 3 runs perpendicular to the axis A. Overall, the surface of the slide turned toward the combustion chamber thus has an L-shaped cross section in a plane that includes axis A (for example the plane of the drawing in FIG. 1).

The slide 105 is accommodated in a recess 103 in a housing that encloses the combustion chamber. In said recess, the position of the slide 103 can be adjusted parallel to the central axis A. For this, an external thread 108 is made on a rear end of the slide 105. The external thread runs in an internal thread of a gear 109 that is rotatably mounted and supported in an axial direction. A second gear 110 drives the first gear 109, so that the slide 105 is adjustable in the axial direction by the turning of the thread.

The adjustment of the slide can take place manually according to requirements, for example via an adjusting wheel (not shown). However, an adjustment can also be done by means of an electronic control device. In this case, an at least partially automatic setting of the driving energy can take place by means of an electronic device control. The specifications necessary for this, for example the type and dimensions of the workpiece, can be taken by an operator. Alternatively or in addition, sensory information, for example on the type of fastener that is to be set, can be used.

An exhaust channel 111 branches from the recess 103, where in this example the exhaust channel in its further course leads forward and in the driving direction. The exhaust channel here is made partially as a recess, milling and/or in particular a drilling that is offset from recess 103 in the housing surrounding the combustion chamber. In an embodiment example that is not shown, the exhaust channel in its further course leads to the rear and opposite the driving direction. With slide 105 closed, the exhaust channel 111 is covered by the body of the slide 105 and is completely closed.

If the slide 105, starting from the closed position in FIG. 1, is moved by the mechanism 106 into the unblocked position as in FIG. 2, in a first segment of movement, an unblocking of the exhaust channel 111 already results. Moreover, even with a small movement, a first additional volume 112 at the bottom of the piston and another additional volume 113 in the side wall 101 in the region of the forward end of the slide 105 are unblocked.

The expanding gas of the propellant charge can already expand immediately at the beginning of the movement of the piston element 2 into the first additional volume 112. An expansion into the second additional volume can take place as soon as a rear end of the piston wall has reached a corresponding position. The farther the slide 105 is adjusted in the direction of the unblocked position, the earlier said position will be reached.

With still further adjustment of the slide 105 there then takes place a continuously increasing unblocking of the inlet opening of an additional exhaust channel 111a. In the case of the shape of slide 105 and additional exhaust channel 111a that is shown, the combustion gases can escape into the exhaust channel 111a in every position of the piston element 2, in so far as the exhaust channel is released in accordance with the slide position.

FIG. 4 shows a version that has been modified with respect to the embodiment example just described. In principle, the slide 105 is shaped as in the preceding example. In FIG. 4 it is in the completely unblocked position.

The exhaust channel 111 is made here as a channel running forward parallel to axis A and adjacent to the slide 105. A rear end of the exhaust channel 111 extends up to the back of the plane of the bottom of the combustion chamber 3.

Through this, the exhaust channel 111 becomes unblocked with any setting of the slide 105. However, the gases cannot escape into the exhaust channel 111 with the partially unblocked slide until the piston element 2 has been advanced. When the slide is completely unblocked (see FIG. 4), the gases already escape into the exhaust channel when the piston element 2 is in the base position, since the forward end of the slide 105 has been pulled back to the plane of the combustion chamber bottom.

The additional volume 112 is present as in the first embodiment example and can act as a closed volume for a first segment of the piston travel at least for a partially unblocked slide 105.

FIGS. 5 to 7 show another embodiment example of the invention. In contrast to the preceding examples, the slide 105 here does not end after a portion of the length of the combustion chamber 3. Rather, the slide 105 extends in a closed position over the entire length of the combustion chamber. Similar to the preceding examples, the slide is accommodated in a guide channel 103 in the form of a recess in the side wall 101 of the combustion chamber 3. In this example, the guide channel 103 for the slide 105, however, extends over the entire length of the combustion chamber 3 and leads to an exhaust channel 111 at a forward end of the combustion chamber.

The exhaust channel 111 in this case runs on a guide 114 of the piston element 2 that is upstream of the combustion chamber 3 and ends in a storage compartment (not shown). By means of the combustion gases collected in the storage compartment, the piston element 2 is returned to the starting position in a known way at the end of the driving operation.

In accordance with the three-dimensional view of the slide 105 shown in FIG. 7, the slide is made as an essentially prismatic body, which has a male part 115 projecting at the side. The desired position of the slide can be set in the guide 103 by means of the male part 115. For this, an appropriate mechanism (not shown) of the control element can be connected to the male part 115 of the slide 105.

In a forward, closed position of the slide 105 (see FIG. 5), the slide runs in recess 103 up to the start of the exhaust channel 111. In this position, the entire side wall 101 of the combustion chamber is cylindrically shaped without recesses. Thus there is no reduction of the driving energy or a maximum of the driving energy.

FIG. 6 shows the slide in a partially withdrawn position, through which a reduced driving energy is achieved. The further slide 105 is withdrawn, the earlier the rear end of the piston element 2 covers the end of the slide, and the earlier the gases of the propellant charge are exhausted. Here, the unblocked part of the guide 103 of slide 105 acts as an elongated part of the exhaust channel 111.

Through the specific shape of the slide in FIGS. 5 to 7, no closed additional volume of the combustion chamber 3 is achieved by an adjustment of the slide 105. In a modification that is not shown, the slide 105 can, however, have a step as in the preceding examples, through which a slidable partial surface of the bottom surface of the combustion chamber is formed, even in this example.

The following description concerns optimized designs of the combustion chamber of the driving-in device by means of a separating member. Although a control element for changing the driving energy is not shown in FIGS. 8 to 13, the designs of the combustion chamber with a separating member can be combined with any of the above designs of a control element 104, according to need.

The combustion chamber 3 is divided by a separating member 5 across the central axis A. On the side of the cartridge seat 4 there is a first partial chamber 3a of the combustion chamber, and on the side of the piston 2 there is a second partial chamber 3b of the combustion chamber 3.

In FIGS. 8 to 13, the piston is maximally drawn back, so that at the time of ignition the second partial chamber 3b comprises only the depression 2b and at most a narrow gap between the piston 2 and the separating member 5.

The separating member 5 in this case is made as a component that can be screwed into the combustion chamber 3 by means of an external thread 7. However, the separating member can also be made in one piece with the rest of the combustion chamber or otherwise combined with the combustion chamber as a separate component.

The separating member 5 has a plurality of through-holes 6, which in this case are made as drillings that run parallel to axis A. The through-holes 6 are arranged around a central region 8 of the separating member 5 that has a closed and unbroken surface. The smallest diameter of the central, unbroken region 8 in a plane perpendicular to axis A is about 35% greater than a diameter of the cartridge that has been opened after ignition. In this case, this corresponds to about the diameter of a combustion chamber-side opening of the cartridge seat or a surface of the pyrotechnic charge aimed into the combustion chamber.

In this case it is assumed in the ideal that the combustion gases and powder grains, charge particles or the like discharged with them enter the combustion chamber initially parallel to the central axis. At least immediately after ignition and over a certain distance, the expanding charge therefore moves chiefly in a prismatic discharge region along the central axis, the extent of which is defined by the outline of the surface of the charge. In the embodiment examples of the invention given here, all of the through-holes 6 of the separating member lie outside of a cross section of the discharge region having the surface area of the separating member. The discharge region is designed as a cylinder in correspondence with the round cartridge hole.

Moreover, a depression 9 is made in the central region 8 of the separating member 5. The depression 9 runs rotationally symmetrically about the central axis A. It is made bowl-shaped and has a flat bottom 9a. A diameter of the depression 9 tapers from a largest diameter d at its upper edge to a smallest diameter at the level of the bottom 9a. The walls of the depression 9 have both inclined and straight segments. The maximum depth of the depression 9 is in this case about 60% of the largest diameter d.

In the plane of the upper edge of the depression 9, the closed surface of the central region 8 extends to a step 10. The step 10 rises from the surface of the central region 8 in the axial direction up to a top of the combustion chamber 3. The separating member 5 here is pressed against the top by the step 10. This is achieved by screwing the separating member 5 appropriately into the combustion chamber 3.

The step 10 forms legs 11, which are aimed radially inward, between each of the adjacent through-holes 6. Correspondingly, there remain radially directed channels 12 between the legs 11, through which the combustion gases and particles of the charge flow from the central region 8 initially radially outwardly and then are deflected into the through-holes 6.

The invention now functions as follows in reference to the separating member:

After ignition of the cartridge, not-yet combusted particles are accelerated in front of a front of combustion gases through the forward cartridge opening into the first partial chamber 3a. After a short distance, this partially not-yet combusted charge arrives at the bowl-shaped depression 9 of the closed central region 8 of the separating member 5. Dispersion and turbulization of the powder grains and combustion gases takes place there, and the powder grains ignite further and burn. This reacting and expanding mixture passes in a largely radial direction between the legs 11 and is deflected into the through-holes 6.

As they flow through the through-holes 6, the particles of the charge are already largely combusted, so that larger unburnt charge residues are not present either in the through-holes or in the subsequent second partial chamber 3b. This prevents unfavorable deposits and/or clogging of the through-holes 6. At the same time, a controlled and uniform expansion of the combustion gases in the second partial chamber is promoted so that an optimum acceleration of the piston 2 takes place.

In the case of the second embodiment example of a separating member shown in FIG. 11, a different shape of the depression 9 is envisioned. As in the first example, the depression is made as a bowl-shaped recess, but the walls of the depression are more steeply and continuously inclined.

In the embodiment example separating member shown in FIG. 12, the shape of the depression 9 is largely as in the example in FIG. 11. In addition, a projecting, conical projection 13 is made over the bottom of the depression. Strong dispersion and turbulization of the combustion gases takes place due to the conical projection 13.

In the embodiment example of a separating member shown in FIG. 13, the depression 9 does not have a flat bottom, but rather overall has a nearly parabola-shaped cross section. Such a shape is especially well suited for avoiding deposits.

It is understood that the invention is not limited to the shapes of depression 9, which are shown only as examples.

Overall, a system for driving a fastener into a workpiece is made available by a driving-in device described above in combination with a propellant charge and a selection of fasteners. In this case, the system comprises a plurality of different fasteners, where only one kind of propellant charge is necessary to cover a complete range of driving energies.

The driving energy transmitted to the piston element ranges from a minimal driving energy of 90 joules up to a maximum driving energy of 325 joules while using the same propellant charge.

1. A driving-in device, comprising
a hand-held housing with a piston element accommodated therein for transmission of energy to a fastener that is to be driven;
a propellant charge;
a combustion chamber disposed between the propellant charge and the piston element the combustion chamber extending about a central axis (A);
and a control element, for adjustably setting energy transmitted from the propellant charge to the piston element, the control element comprising
a movable slide that forms a segment of a side wall of the combustion chamber adjacent to the piston element.

2. The driving-in device as in claim 1, wherein the slide is movable parallel to the axis (A).

3. The driving-in device as in claim 1, wherein the slide is movable transversely to the axis (A).

4. The driving-in device according to claim 1, wherein the combustion chamber has an additional volume that can be set by an adjustment of the slide.

5. The driving-in device according to claim 4, wherein by adjusting the slide starting from a closed position, an increasing additional volume of the combustion chamber first becomes unblocked, and by further adjusting the slide, the exhaust channel becomes unblocked.

6. The driving-in device according to claim 4, wherein by adjusting the slide starting from a closed position, the exhaust channel first becomes unblocked, and by further adjustment of the slide, an increasing additional volume of the combustion chamber becomes unblocked.

7. The driving-in device according to claim 4, wherein by adjusting the slide starting from the closed position, an increasing additional volume of the combustion chamber and of the exhaust channel begin becoming unblocked at the same time.

8. The driving-in device according to claim 1, wherein, when the slide is closed, the side wall of the combustion chamber forms a closed surface of rotation about the central axis (A).

9. The driving-in device according to claim 1, wherein the segment of the side wall formed by the slide has a concave surface.

10. The driving-in device according to claim 1, wherein a surface of the slide has two partial surfaces, where a first partial surface forms the segment of the side wall of the combustion chamber, and where a second partial surface forms a segment of a bottom surface (102) of the combustion chamber.

11. The driving-in device according to claim 1, wherein the slide, in a closed position, extends over the entire length of the combustion chamber and a guide channel of the slide leads into an exhaust channel at a forward end of the combustion chamber.

12. The driving-in device according to claim 1, wherein
the combustion chamber is divided into a first partial chamber adjacent to the propellant charge and at least one second partial chamber adjacent to the piston element by a separating member having a plurality of through-holes,
where, in the first partial chamber, a discharge region for the propellant charge includes the central axis (A) and, the discharge region extends between the propellant charge and a central region of the separating member.

13. The driving-in device as in claim 12, wherein the discharge region is bounded at the central region of the separating member by a closed surface of the separating member and/or the central region of the separating member has a depression.

14. The driving-in device according to claim 1, wherein in standard operation, a maximum driving energy that can be set by the control element corresponds to at least twice that of a minimum driving energy that can be set by means of the control element for the same propellant charge.

15. A system for driving a fastener into a workpiece comprising the driving-in device according to claim 1, and a plurality of different fasteners, where the system for covering a range of driving energies comprises only propellant charges having essentially the same propellant charge energy.

16. The driving-in device of claim 1, wherein the propellant charge is an exchangeable propellant charge.

17. The driving-in device according to claim 2, wherein moving the slide adjustably sets an exit cross section of an exhaust channel.

18. The driving-in device of claim 3, wherein the slide is moveable perpendicularly.

19. The driving-in device according to claim 3, wherein moving the slide adjustably sets an exit cross section of an exhaust channel.

20. The driving-in device according to claim 2, wherein the combustion chamber has an additional volume that can be set by an adjustment of the slide.
